(19) United States
(12) Patent Application Publication
(10) Pub. No.: US 2026/0216762 A1
(43) Pub. Date: Jul. 30, 2026

(54) SYSTEM, METHOD AND APPARATUS FOR CLEANING A GRAIN BIN OR SILO

(71) Applicant: David Dale Alig, Fort Recovery, OH (US)

(72) Inventor: David Dale Alig, Fort Recovery, OH (US)

(21) Appl. No.: 19/041,507

(22) Filed: Jan. 30, 2025

(51) Int. Cl. B08B 9/08; B65D 88/08; B65D 88/54

(52) U.S. Cl. CPC B08B 9/0813; B08B 9/0808; B65D 88/08; B65D 88/54; B65D 2588/02; B65D 2588/54

(57) ABSTRACT

A blower mount couples a blower near a radially distal end of a sweeper in a grain bin. The blower mount positions the blower in a configuration to discharge blown air, under generally normal atmospheric pressure conditions toward at least one or both of the lower surface of the grain bin or a sidewall of the grain bin. The moving grain can then be moved toward a center of the grain bin for subsequent discharge out of the grain bin. Various embodiments of the blower mount are possible, such as a blower mount formed generally as a plate and a blower mount formed generally from a round rod, which may be coiled to form a torsion spring.

### BACKGROUND OF THE INVENTION

### Field of the Invention

This disclosure is directed to a grain bin sweeper having a sweeper arm for use in a grain bin or silo.

### Description of the Related Art

Grain bins or silos are fundamental to modern agriculture, serving as structures for the storage and preservation of harvested grains such as corn, wheat, and soybeans. These bins or silos not only safeguard the grain from environmental elements but also play a role in maintaining its quality over time. Grain bins are typically constructed as large, cylindrical structures composed of a rigid material, such as corrugated galvanized steel. This rigid material selection is often robust in strength and durability capable of withstanding both internal pressures and external environmental conditions. The cylindrical design, which has a circular profile or plan-view cross section helps ensure uniform distribution of the lateral pressure exerted by the grain against the walls, enhancing structural integrity. The bins or silos may feature a conical roof that facilitates efficient runoff of rain and snow, minimizing moisture infiltration and potential water damage. Still further, some bins or silos may have integrated ventilation mechanisms that regulate internal temperature and humidity, critical factors in grain preservation.

A grain bin is ordinarily erected and supported by a base/foundation, such as a concrete base or foundation. Typically, at the foundation of the grain bin lies a lower auger or another mechanical component responsible for conveying grain out of the bin during unloading operations. The lower auger is a helical screw encased within a tube, extending horizontally along the bin's base. Upon activation, the auger rotates, propelling grain from the interior towards the discharge point through rotational motion.

Understanding the rheological behavior of grain is beneficial for optimizing storage and handling processes. Particularly, granular flow dynamics exhibit unique flow characteristics, distinct from conventional solids or liquids. When grain is introduced into the bin, it forms a peak and settles at its angle of repose. During unloading, grain tends to flow from the top center downwards, potentially leading to uneven emptying. This natural flow can cause issues such as bridging (e.g., grain forms an arch over the discharge point) or rat-holing (e.g., grain flows through a narrow channel, leaving residual grain along the sides), disrupting efficient unloading. Further, the top center-down flow of grain discharging from the bin can leave grain near the outer perimeter along an inside wall of the bin when the bin is nearly empty.

During unloading, once the grain bin is nearly empty, to assist the granular flow dynamics or other rheological properties of the grain that remain near the outer perimeter, many bins or silos have a sweeper located at the bottom thereof. The sweeper is a mechanical arm that rotates around the bin's central axis when the bin is nearly empty to assist with moving the remaining grain toward the center. The sweeper and its rotating arm may be equipped with augers or paddles, extending from the center to the bin's perimeter. As it rotates along the bin floor, the sweeper agitates the grain, encouraging movement towards the center discharge point. This agitation facilitates a more consistent and complete unloading and/or cleaning process and provides greater control of the rheology of the granular flow.

Some sweepers are automated, allowing for continuous operation without the need for manual intervention. These automated sweepers may have sensors to monitor grain levels, providing real-time data for proactive management. These integrated systems can activate sweepers automatically in response to changing conditions, such as when the grain has been sufficiently emptied and only the perimeter grain remains. Otherwise, the grain atop the sweeper may be too heavy to allow the sweeper to rotate, which could lead to damage. Utilizing data from sensors enables predictive maintenance and informed decision-making to encourage full emptying of the grain from the bin.

Yet, with all the advancement of sweepers, either automated or manual, to control the grain within the bin or silo, problems still exists. Namely, even with the modern advancement of sweepers in grain bins or silos, a tendency still exists for grains to get stuck or lodged near the outer perimeter of the grain bin or silo, typically along the bottom edge where the lower end of the cylindrical wall meets the base or foundation.

To combat this problem, others have placed nozzles along the sweeper arm that emit jets of compressed air into the grain mass. To deliver the compressed air, tubing runs along the sweeper arm, supplying compressed air from the source to the nozzles. An external reservoir that stores air at high pressure supplies the system with the necessary compressed air. As the sweeper arm rotates, it mechanically agitates the grain on the bin floor, pushing it towards the center. While the air nozzles release jets of compressed air into the grain, reducing inter-particle friction and cohesion. The combination of mechanical and pneumatic forces fluidizes the grain, allowing it to flow more like a liquid, which promotes uniform movement and prevents stagnation.

Even with the advent of sweepers that deliver air through the nozzles on the sweeper arm, problems continue to exist. Namely, the air delivery assembly of these sweeper arms with nozzles require significant structural components to deliver the air to the nozzles. For example, an industrial air compressor is needed to store air at the required pressure. Additionally, durable hoses or pipes attached to the sweeper arm, delivering air from the tank to the nozzles. The lines must withstand the mechanical movement of the sweeper and resist wear from grain abrasion. Secure fittings are needed to prevent air leaks and maintain consistent pressure at the nozzles. And, valves and regulators control the air pressure and flow rate, allowing adjustments based on operational needs.

### SUMMARY OF THE INVENTION

What is needed is an improved air delivery system or assembly integrated into a sweeper arm of a bin assembly that eliminates all the extraneous components of these complex pressurized air delivery systems. Aspects and embodiments of the present disclosure address this need by providing a blower mounted on the sweeper arm at or near a radially distal end thereof. The blower may move air from the sweeper to blow the grain, yet does not require all the overly-complex air delivery requirements of compressed air systems ejecting air through nozzles.

In one aspect, an exemplary embodiment of the present disclosure may provide a blower mount for a sweeper that pivots near a bottom of a grain bin, the blower mount comprising: a body having a first end and a second end, wherein the first end is fixedly connected to the sweep arm near a radially distal end thereof, and wherein the second end is fixedly connected to a blower that, when powered and selectively actuated, emits blown air toward at least one of the bottom of the grain bin or a sidewall of the grain bin; wherein the mount is configured to couple the blower to the sweeper. This exemplary embodiment or another exemplary embodiment may further provide that the body of the mount extends rearward from the sweeper relative to a forward rotational path of travel of the sweeper. This exemplary embodiment or another exemplary embodiment may further provide that the body comprises: an upwardly facing top surface; and a downwardly facing bottom surface. This exemplary embodiment or another exemplary embodiment may further provide that the upwardly facing top surface is flat and planar in cross section. This exemplary embodiment or another exemplary embodiment may further provide that the downwardly facing bottom surface is flat and planar in cross section. This exemplary embodiment or another exemplary embodiment may further provide that the body is formed from a flat bar, wherein the flat bar is bent or curved between the first end and the second end to impart a resilient force exerted by the flat bar to support the blower.

This exemplary embodiment or another exemplary embodiment may further provide that the body comprises: a substantially continuous outer surface that has an at least partially curved cross section. This exemplary embodiment or another exemplary embodiment may further provide that the body is formed from a round rod, wherein the round rod is coiled between the first end and the second end to define a spring, wherein the spring resiliently moves and supports the blower.

In another aspect, another exemplary embodiment of the present disclosure may provide a sweeper assembly for a grain bin comprising: an elongated body defining an arm that extends from a proximal first end to a distal second end, wherein the arm rotates about a vertical pivot axis near the proximal first end, wherein during rotation the arm moves close to a lower surface of the grain bin to stir or agitate the grain within the grain bin; and a blower mounted to the arm near the distal second end, wherein the blower, when powered and selectively actuated, emits blown air toward at least one of the lower surface of the grain bin or a sidewall of the grain bin. This exemplary embodiment or another exemplary embodiment may further include a mount that mounts the blower to the arm, wherein the mount includes a mount body having a first end and a second end, wherein the first end is fixedly connected to the arm near the distal second end, and wherein the second end of mount body is fixedly connected to the blower. This exemplary embodiment or another exemplary embodiment may further provide that the mount body extends rearward from the arm relative to a forward rotational path of travel of the arm. This exemplary embodiment or another exemplary embodiment may further provide that the mount body comprises: an upwardly facing top surface; and a downwardly facing bottom surface. This exemplary embodiment or another exemplary embodiment may further provide that the upwardly facing top surface is flat and planar in cross section. This exemplary embodiment or another exemplary embodiment may further provide that the downwardly facing bottom surface is flat and planar in cross section. This exemplary embodiment or another exemplary embodiment may further provide that the mount body is formed from a flat bar, wherein the flat bar is bent or curved between the first end and the second end of the mount body to impart a resilient force exerted by the flat bar to support the blower.

This exemplary embodiment or another exemplary embodiment may further provide that the mount body comprises: a substantially continuous outer surface that has an at least partially curved cross section. This exemplary embodiment or another exemplary embodiment may further provide that the mount body is formed from a round rod, wherein the round rod is coiled between the first end and the second end of the mount body to define a spring, wherein the spring resiliently moves and supports the blower.

In yet another aspect, another exemplary embodiment of the present disclosure may provide a method comprising: selectively activating a blower mounted to a sweeper in a grain bin, wherein the blower is mounted near a radially distal end of the sweeper; rotating the sweeper about a center pivot axis; blowing air, from the blower, toward at least one of a lower surface of the grain bin or a sidewall of the grain bin while the sweeper is rotating; and causing grain to move toward a center of the grain bin. This exemplary embodiment or another exemplary embodiment may further include blowing air at atmospheric pressure. This exemplary embodiment or another exemplary embodiment may further provide that the blower is mounted in a cantilevered manner and positioned rearward of the sweeper relative to a rotational path of travel of the sweeper.

In yet another aspect, another exemplary embodiment of the present disclosure may provide a method for retrofitting a sweeper in grain bin comprising: installing a mount near a radially distal end of a sweeper located at a bottom of a grain bin, wherein the mount has a body including a first end and a second end, wherein installing the mount is accomplished by fixedly connecting the first end of the body to the sweeper; installing a blower on the mount, wherein installing the blower on the mount is accomplished by fixedly connecting the blower to the second end of the body of the mount; providing power to the blower; actuating or activating the blower to blow air from an outlet of the blower; rotating the sweeper about a center pivot; blowing air from the blower toward at least one of the bottom of the grain bin or a sidewall of the grain bin while the sweeper is rotating, wherein blown air from the blower is propelled outward from the outlet with increased velocity but at relatively normal atmospheric pressure.

In still another aspect, another exemplary embodiment of the present disclosure may provide a storage bin having an internal cleaning system, the storage bin being adapted or suitable for storing grain or aggregate and having an internal cleaning system comprising at least one control for controlling operating of the internal cleaning system, a sweeper assembly having a drivable sweep arm having a first end pivotally coupled to permit the sweep arm to rotate or pivot in the storage bin, an air generator situated proximate to a second end of drivable sweep arm; and the at least one control being adapted to energize the sweeper assembly to rotatably drive the sweep arm in the storage bin and substantially simultaneously or independently control the air generator to blow air at a predetermined cubic feet per minute in order to cause the grain or aggregate to move away from an interior wall of the storage bin.

This invention, including all embodiments shown and described herein, could be used alone or together and/or in combination with one or more of the features covered by one or more of the following list of features:

The blower mount wherein the body of the mount extends rearward from the sweeper relative to a forward rotational path of travel of the sweeper.

The blower mount wherein the body comprises an upwardly facing top surface; and a downwardly facing bottom surface.

The blower mount wherein the upwardly facing top surface is flat and planar in cross section.

The blower mount wherein the downwardly facing bottom surface is flat and planar in cross section.

The blower mount wherein the body comprises a substantially continuous outer surface that has an at least partially curved cross section.

The blower mount wherein the body is formed from a round rod, wherein the round rod is coiled between the first end and the second end to define a spring, wherein the spring resiliently moves and supports the blower.

The blower mount wherein the body is formed from a flat bar, wherein the flat bar is bent or curved between the first end and the second end to impart a resilient force exerted by the flat bar to support the blower.

The sweeper assembly further comprising a mount that mounts the blower to the arm, wherein the mount includes a mount body having a first end and a second end, wherein the first end is fixedly connected to the arm near the distal second end of the arm, and wherein the second end of the mount body is fixedly connected to the blower.

The sweeper assembly wherein the mount body extends rearward from the arm relative to a forward rotational path of travel of the arm.

The sweeper assembly wherein the mount body comprises an upwardly facing top surface; and a downwardly facing bottom surface.

The sweeper assembly wherein the upwardly facing top surface is flat and planar in cross section.

The sweeper assembly wherein the downwardly facing bottom surface is flat and planar in cross section.

The sweeper assembly wherein the mount body comprises a substantially continuous outer surface that has an at least partially curved cross section.

The sweeper assembly wherein the mount body is formed from a round rod, wherein the round rod is coiled between the first end and the second end of the mount body to define a spring, wherein the spring resiliently moves and supports the blower.

The sweeper assembly wherein the mount body is formed from a flat bar, wherein the flat bar is bent or curved between the first end and the second end of the mount body to impart a resilient force exerted by the flat bar to support the blower.

The method further comprising blowing air at atmospheric pressure.

The method wherein the blower is mounted in a cantilevered manner and positioned rearward of the sweeper relative to a rotational path of travel of the sweeper.

The storage bin wherein the at least one control controls at least one of a sweep arm speed and the air generator and the predetermined cubic feet per minute exhaust from the air generator in response to the grain or aggregate being swept.

The storage bin wherein the air generator is situated on the sweep arm in proximity to the second end such that an exhaust end of the air generator is situated between the distal second end and the interior wall of the storage bin.

The storage bin wherein the air generator further comprises a blower mounted to the sweep arm near the distal second end, wherein the blower, when powered and selectively actuated, emits blown air toward at least one of the lower surface of the storage bin or a sidewall of the storage bin.

The storage bin wherein the assembly further comprises a mount that mounts the blower to the arm, wherein the mount includes a mount body having a first end and a second end, wherein the first end is fixedly connected to the arm near the distal second end of the arm, and wherein the second end of the mount body is fixedly connected to the blower.

The storage bin wherein the second end of the sweep arm cooperates to define a gap between the second end and the interior wall of the storage bin, the air generator being mounted in proximity to the second end such that an exhaust port from the air blower is situated in operative relationship with the gap in order to facilitate blowing fluid into the gap, thereby cleaning a corner defined by a floor of the storage bin and the interior wall of the storage bin.

The storage bin wherein the fluid is air.

These and other objects and advantages of the invention will be apparent from the following description, the accompanying drawings, and the appended claims.

### BRIEF DESCRIPTION OF THE ACCOMPANYING DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a cross sectional perspective view of a grain bin with a sweeper and a blower mounted thereto.

FIG. 2 is an enlarged perspective view of the blower mounted to the sweeper via a blower mount from the region labeled “FIG. 2” in FIG. 1.

FIG. 3 is a top perspective end view of the blower mounted to the end of the sweeper.

FIG. 4 is an end elevation view of the blower mounted to the sweeper.

FIG. 5 is an enlarged perspective view of the blower mounted to the sweeper with a second embodiment of a blower mount.

FIG. 6 is an operational top view of the sweeper and blower within the grain bin.

FIG. 6A is an enlarged operational top view of the sweeper and the blower from the region labeled “FIG. 6A” in FIG. 6.

FIG. 6B is an enlarged operational top view of the sweeper and the blower depicting the sweeper rotating along the path of travel while the blower blows air to move the grain.

FIG. 7 is a top perspective view of an alternative embodiment that utilizes two blowers connected to the sweeper.

FIG. 8 is a top perspective view of another alternative embodiment that utilizes a single blower with two discharge outlets, one discharge outlet behind the sweeper and one discharge outlet in front of the sweeper.

FIG. 9 is a cross sectional perspective view of a grain bin with a sweeper and an alternative method of delivery mounted thereto.

Similar numbers refer to similar parts throughout the drawings.

### DETAILED DESCRIPTION OF THE PREFERRED EMBODIMENTS

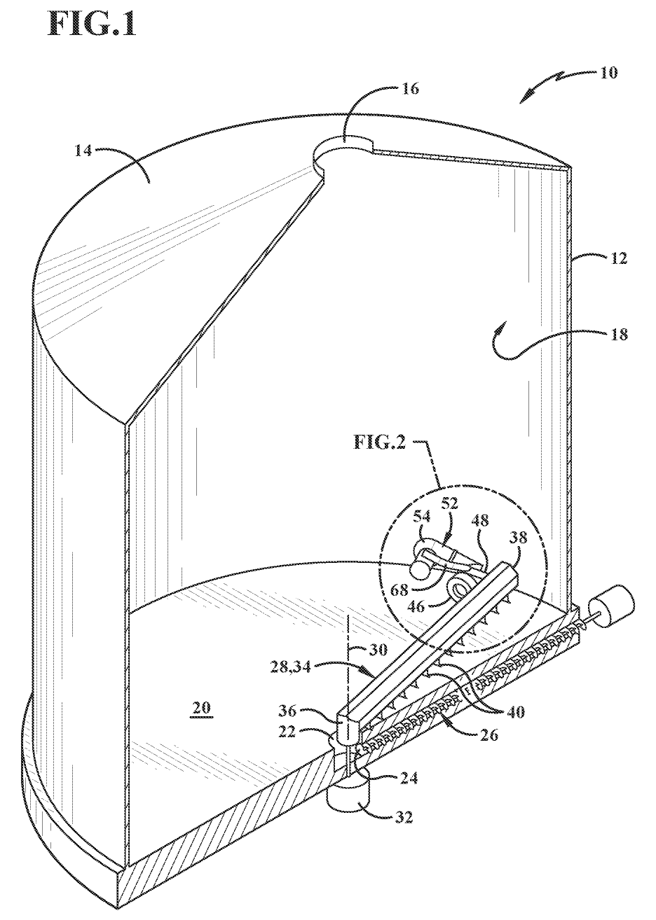

FIG. 1 depicts a grain bin 10 having a generally cylindrical sidewall 12. A conical top 14 may define a central opening 16, wherein the conical top is connected to an upper end of the cylindrical sidewall 12. The angle at which conical top 14 connects with the cylindrical sidewall 12 may equal an angle of repose of grain that is input into an interior volume 18 of the grain bin through the central opening 16. While the embodiments shown depict a grain in the grain bin 10, it should be appreciated that features of the invention in the embodiments described herein may also be used with other types of bins, such as bins that hold sand, agricultural corn or grain, beans, gravel, salt, feed or other agricultural materials

Grain bin 10 may include a base 20. The lower end of the cylindrical sidewall 12 extends upward from the base 20. The base 20 may have a circular perimeter. The base may have a center cavity 22 that is in communication with a discharge bore 24 that extends radially through the base 20. An auger 26 may be disposed within the bore 24, such that the auger 26 rotates to draw grain out from the interior volume 18 of the grain bin 10 for transfer or transport to another location after having been stored in the grain bin 10.

The grain bin 10 may include a sweep arm 28, which may simply be referred to as sweeper 28, that centrally pivots about a central, vertical pivot axis 30 when powered by a motor 32. It is to be understood that the sweeper 28 encourages grain stored in the interior volume 18 into the cavity 22 to be moved through the bore 24 to be output from the grain bin 10.

Sweeper 28 includes an elongated rigid body 34 defining an arm that extends from a proximal first end near 36 the center of the grain bin 10 to a radially distal second end 38. The body 34 may include a plurality of downwardly extending and spaced apart fins 40 that encourage grain to move towards the center cavity 22 as the sweeper 28 rotates about pivot axis 30. Inasmuch as the sweeper 28 rotates about the pivot axis 30, the body 34 may define a radially extending leading edge 42 and a radially extending trailing edge 44.

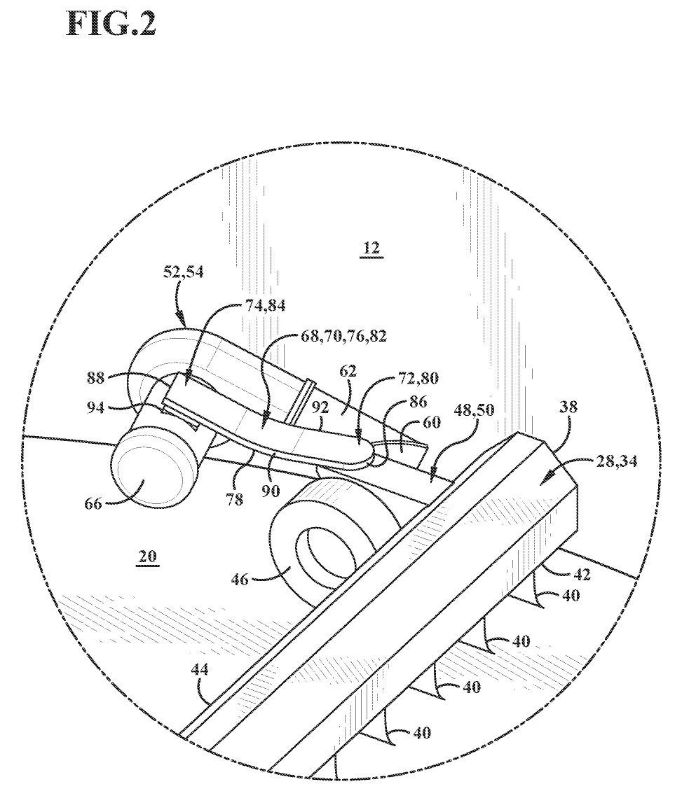

FIG. 2 depicts that the distal end 38 of body 34 of the sweeper 28 may be supported by a wheel 46. The wheel 46 is connected to a wheel mount 48 that extends outward from a rigid connection with the trailing edge 44 of the body 34 of sweeper 28. The wheel mount 48 is a rigid block-like structure defining an upwardly facing upper or top surface 50. The wheel 46 may be rotatably connected to a sidewall or side surface of the wheel mount 48 in a manner that enables the wheel to rotate about a horizontal axis while contacting the surface of the base 20.

A blower or air generator 52 is mounted to the body near the distal second end 38, wherein the blower 52, when powered and selectively actuated, emits blown air toward at least one of the lower surface or base 20 of the grain bin 10 or the cylindrical sidewall 12 of the grain bin 10. In a preferred embodiment, the blower or air generator 52 blows or moves air to clean a corner between the floor of the grain bin 10 and its interior wall. It should be understood, however, that other types of fluid may be used, such as gas, water, cleaning solution or the like without departing from the spirit and scope of the invention. The blower 52 has a housing 54 or casing that defines the outer shell that encloses the blower 52. The housing 54 may be designed to direct the airflow efficiently and protect the internal components of blower 52. Blower 52 may also include an impeller or fan (not shown), which is the rotating part of the blower 52 that draws air into the housing 54 and accelerates it outward through force (either centrifugal or axial force). Impellers have several blades or vanes attached to a central hub. The blower 52 detailed herein may have any type of impeller or fan to move air. For example, the blower could use a centrifugal fan (e.g., a Radial Fans, a Forward-Curved Fans, or a Backward-Inclined Fans, etc.) or an axial fan (e.g., a propeller fan, a tube axial fan, or a vane axial fan, etc.), a hybrid centrifugal-axial fan, or a non-centrifugal and non-axial fan. Furthermore, the blower has at least one inlet, regardless of its orientation. The blower 52 could be a (i) single-suction blower, wherein air enters from one side and exits from and outlet that is perpendicular to the intake, or (ii) a double-suction blower, wherein air enters from both sides of the blower 52, which allows for higher airflow rates, and exits from an outlet that is perpendicular to both inlets, or (iii) an inline blower wherein the inlet or intake is coaxial with the outlet.

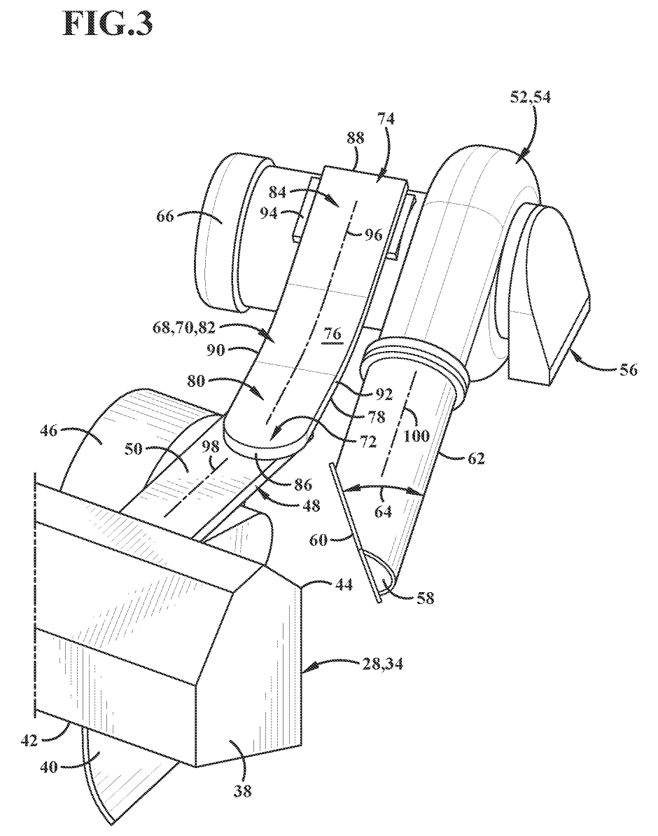

FIG. 3 depicts that the blower 52 includes an inlet 56, which is the opening where the air enters the blower 52. The inlet 56 is usually positioned near the center of the impeller to allow air to be drawn in efficiently. The blower 52 may include or define an outlet or discharge 58, which is the location where the accelerated air exits the blower housing.

The outlet 58 may be at least partially defined by a plate 60 that truncates a portion of the housing 54 to decrease the area of the opening of the outlet 58 relative to an inner diameter of a tubular portion 62 of the housing 54. The angle 64 at which the plate 60 truncates the tubular portion 62 may be in a range from about 10 degrees to about 80 degrees. In one particular embodiment, the angle 64 of plate 60 relative to a central axis of the tubular portion 62 is about 60 degrees.

The blower 52 also has a motor 66, which provides the driving force for the impeller or fan, thereby providing the mechanical power needed to rotate the impeller and generate airflow. Motor 66 can be electric, gasoline, or diesel-powered, depending on the application, however it is envisioned that an electric motor is preferable. The blower 52 may have other necessary components such as one or more bearing assemblies and seals to ensure proper operation of the blower 52.

The usage of the blower 52 detailed herein has some advantages over other air delivery techniques, such as those that would use compressed air ejected from nozzles. For example, the blower may be an all-in-one unit with a housing, fan, and motor, which simplifies setup and operation. Through the use of the blower 52, there is no need for air tanks, air lines, nozzles, or valves, reducing potential points of failure and maintenance needs. Further, the blower 52 can operate at a lower power level compared to a compressed air system, especially for continuous airflow applications. Using less power can lead to significant energy savings over time, reducing operational costs. Additionally, with fewer components than compressed air systems, the blower 52 is generally easier and quicker to install, and has fewer maintenance tasks and lower maintenance costs.

As such, as used herein, the term “blown air” refers to air, generated by devices such as the blower 52, that is moved by the action of a fan or impeller. This mechanism draws in ambient air and propels it outward with increased velocity but at normal atmospheric pressure. One characteristic of the blown air is that it enhances airflow through mechanical means without significantly altering the air's inherent pressure. This is different from and does not include compressed air that originates from a tank where air has been pressurized significantly above atmospheric levels, and then released through a nozzle.

The blower 52 is mounted to the sweeper 28. More particularly, there is a blower mount 68 that connects or couples the blower 52 to the sweeper 28. The present disclosure details various embodiments of the blower mount 68 that can be utilized to mount the blower 52 to the sweeper 28.

FIG. 2 through FIG. 4 depict a first embodiment of the blower mount 68. The blower mount 68 includes a body 70 defining a first end 72 and a second end 74. The first end 72 is fixedly connected to the sweeper 28. In one particular embodiment, the first end 72 is fixedly or rigidly connected to the upper surface 50 of wheel mount 48 and extends outwardly therefrom in a cantilevered manner. Particularly, the blower mount 68 extends outward in a direction extending away and rearward from the trailing edge 44 of the elongated body 34 of sweeper 28. The second end 74 of the blower mount 68 is fixedly or rigidly connected to a portion of the blower 52. In the shown embodiment, the second end 74 of the blower mount 68 is connected to motor 66, however, the second end 74 could be connected to another portion of the blower 52, such as any portion of the housing 54.

This arrangement or configuration of the blower mount 68 causes the blower mount 68 to extend rearward from the sweeper 28 relative to a forward rotational path of travel of the sweeper 28, which is described in greater detail herein.

With continued reference to FIG. 2-FIG. 4, the body 70 of blower mount 68 includes an upwardly facing top surface 76 and a downwardly facing bottom surface 78. The surfaces 76, 78 define a substantial or major portion of the surface area of the body 70. A minor sidewall of the body 70 may be defined by the thickness of the body 70 defined between the surfaces 76, 78. As such the body may be generally shaped as an elongated plate extending between the ends 72, 74.

When the body 70 of the blower mount 68 is formed generally in as a plate, the plate may be slightly bent to define different sections or portions thereof. The body 70 may include a first section 80 that defines the first end 72, a central bent or curved section 82, and a second section 84 that defines the second end 74, wherein the central section 82 is located between the first and second sections 80, 84. The bent or curved central section 82 may provide a biasing force (similar to a spring) that urges or imparts force to the blower 52 when mounted to the sweeper 28 via the blower mount 68. The thickness of the body 70 of the blower mount 68, as well as the degree at which the central portion 82 is bent, should depend on the weight or mass of the blower 52 that is connected thereto. Further, the bend in the central portion 82 is such that the second portion 84 of the body 70 is disposed vertically above the first portion 80. As such, the top surface 76 of the body is slightly concave at the central portion 82 and the bottom surface 78 is slightly convex at the central portion 82. Additionally, a portion of the upwardly facing top surface 76, such as at the first portion 80 or the second portion 84, may be flat and planar in cross section. Additionally, a portion of the downwardly facing bottom surface 78, such as at the first portion 80 or the second portion 84, may be flat and planar in cross section.

FIG. 3 further depicts that the first end 72 of blower mount 68 may be defined by a curved edge 86. In one particular embodiment, the curved edge 86 may be convexly curved. The second end 74 of the blower mount 68 may be defined by a straight linear edge 88. The blower mount 68 may also include a first side edge 90 and a second side edge 92 that extend generally parallel to each other, when viewed from above, between the edge 86 and edge 88. The first and second side edges 90, 92 may be perpendicular to the linear edge 88 at the second end 74.

In the shown embodiment, the second end 74 of the blower mount 68 is rigidly coupled to a corresponding mounting surface 94 of the motor 66 of blower 52. The mounting surface 94 on the motor 66 extends upward from an outer surface of the motor housing. The mounting surface 94 may be flat and planar to allow the downwardly facing flat lower surface 78 on the second portion 84 to abut the mounting surface 94. In one particular embodiment, the mounting surface 94 is generally rectangular or square in shape such that the edge 88 on the blower mount is parallel to an edge of the mounting surface 94.

The blower mount 68 has a central longitudinal axis 96 that extends centrally through the length of the body 70 of blower mount 68 from the first end 72 to the second end 74. The axis 96 is angled relative to a central longitudinal axis 98 of the wheel mount 48. Stated otherwise, axis 96 is not parallel to axis 98. In one embodiment, an angle is defined between axis 96 and axis 98 that is greater than about 135 degrees but less than 180 degrees. The angular offset of the blower mount 68 relative to the wheel mount 48 causes the blower 52 to be angled radially outward such that the discharge outlet 58 of the blower 52 causes blown air to be directed toward at least one (or both) of the lower surface at the base 20 of the grain bin 10 or the sidewall 12 of the grain bin 10.

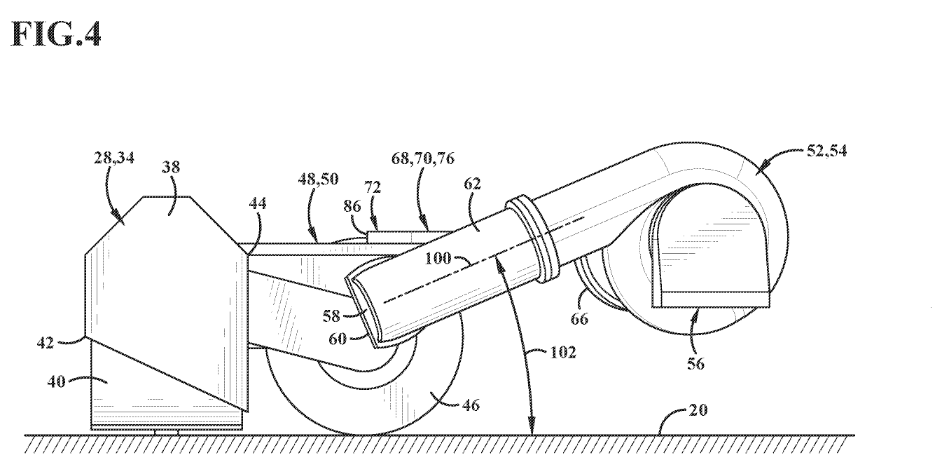

FIG. 4 depicts that the blower mount 68 positions the blower 52 rearward of the trailing edge 44 on the sweeper 28. The blower mount 68 causes the blower 52 to have its discharge outlet 58 being pointed generally downward toward the lower surface of the base 20. The tubular portion 62 of the blower 52 extends centrally along an axis 100 that is angled at an acute angle 102 relative to the surface of the base 20. In one embodiment, the angle 102 defined between axis 100 and the surface of base 20 is less than about 45 degrees. In one particular embodiment, the angle 102 is about 30 degrees.

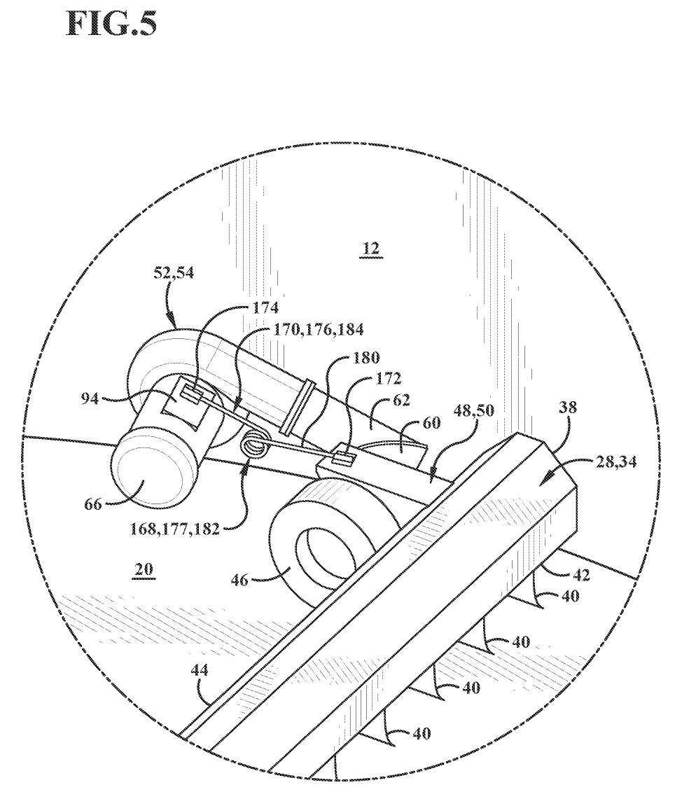

FIG. 5 depicts another embodiment of a blower mount 168 that is used to connected the blower 52 to the sweeper 28. As such, many referenc numerals that correspond to similar components are not repeated for brevity. Blower mount 168 includes a body 170 defining a first end 172 and a second end 174. The first end 172 is fixedly connected to the sweeper 28. In one particular embodiment, the first end 172 is fixedly or rigidly connected to the upper surface 50 of wheel mount 48 and extends outwardly therefrom in a cantilevered manner. Particularly, the blower mount 168 extends outward in a direction extending away and rearward from the trailing edge 44 of the elongated body 34 of sweeper 28. The second end 174 of the blower mount 168 is fixedly or rigidly connected to a portion of the blower 52. In the shown embodiment, the second end 174 of the blower mount 168 is connected to motor 66, however, the second end 174 could be connected to another portion of the blower 52, such as any portion of the housing 54. This arrangement or configuration of the blower mount 68 causes the blower mount 168 to extend rearward from the sweeper 28 relative to a forward rotational path of travel of the sweeper.

With continued reference to FIG. 5, the body 170 of blower mount 168 includes a convexly curved outer surface 176 that defines a substantial or major portion of the surface area of the body 170. The body may be generally shaped as an elongated round rod. When the body 170 of the blower mount 168 is formed generally in as a round rod, the round rod may be coiled near the center thereof to define a spring, such as a torsion coil spring. The coil 177 is located between the first end 172 and the second end 174. The body 170 may include a first section 180 that defines the first end 172, a central section 182 defined by coil 177, and a second section 184 that defines the second end 174, wherein the central section 182 is located between the first and second sections 180, 184. The coil 177 may provide a biasing force or spring force that urges or imparts force to the blower 52 when mounted to the sweeper 28 via the blower mount 68. The thickness of the body 170 of the blower mount 168, as well as number of coils 177, should depend on the weight or mass of the blower 52 that is connected thereto. Further, the coil 177 in the central portion 82 is such that the second portion 184 of the body 170 is disposed vertically above the first portion 180 which causes the discharge outlet 58 of the blower 52 to be pointed downward, as was shown previously in FIG. 4.

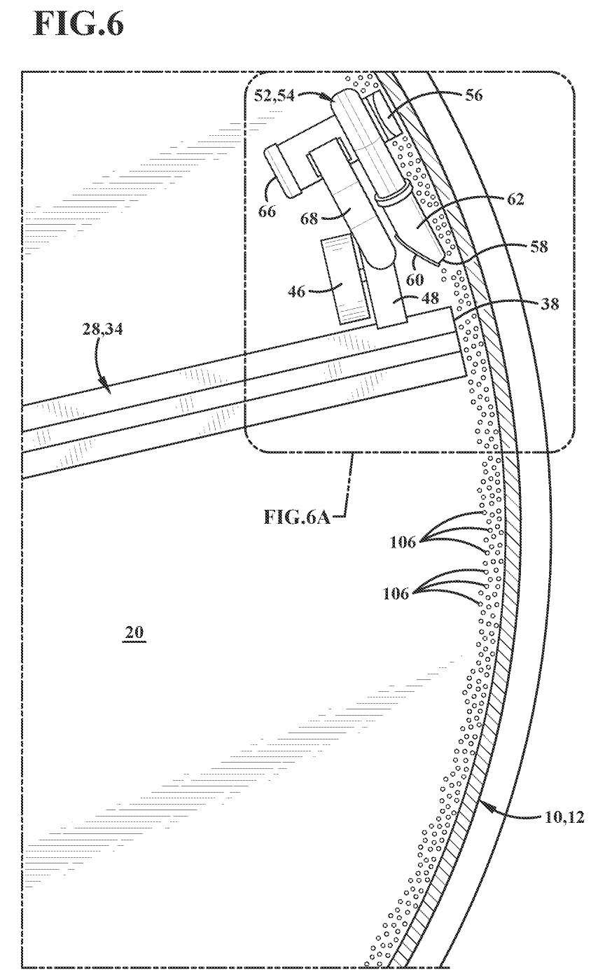

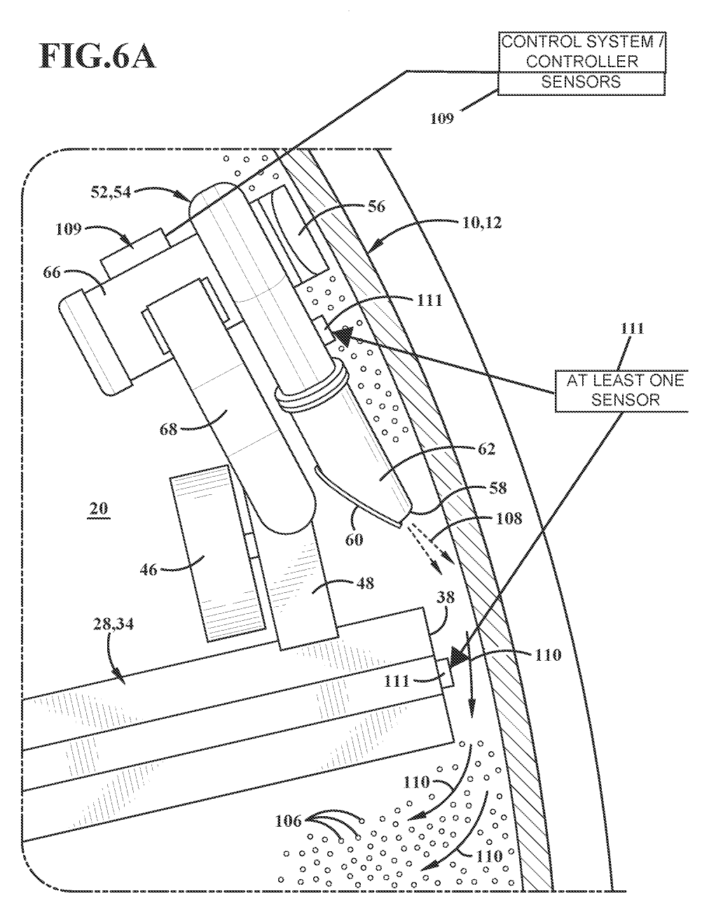

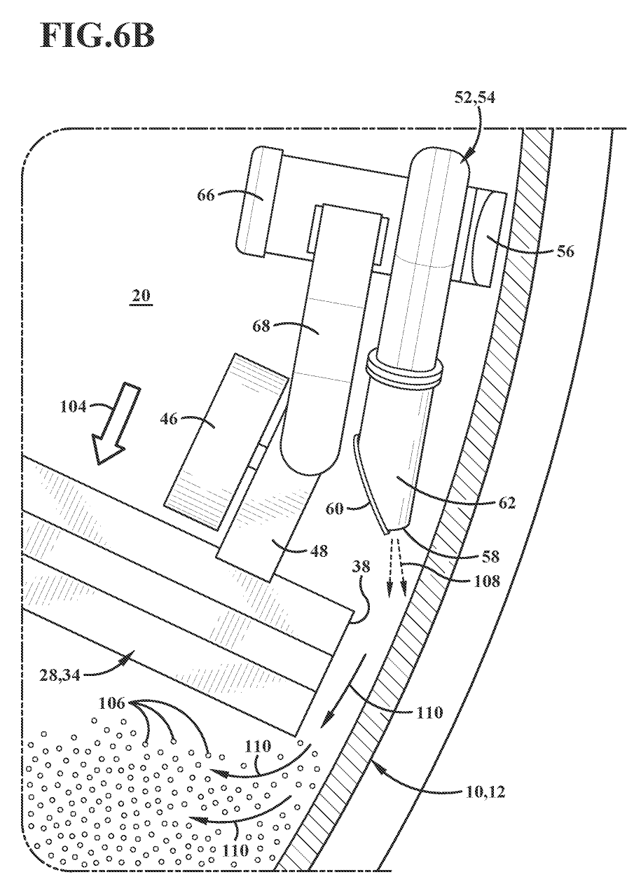

FIG. 6, FIG. 6A and FIG. 6B depict the operation of the blower 52 relative to the sweeper 28. Although these figures depict the operation being accomplished with blower mount 68, it is to be understood that the operation would be possible and effective with blower mount 168 as well. When a substantial majority of the grain has been removed from the silo through the center discharge bore 24, via auger 26 (or another mechanism that achieves the same result), some grain may remain near the interior perimeter of the bin 10. The sweeper 28 rotates about center pivot axis 30 along a rotational path of travel as indicated by arrow 104. As the sweeper 28 rotates along path 104, the sweeper agitates the remaining grain 106 stored within the bin 10 to encourage the grain 106 to move towards the center of the bin so it may be discharged via bore 24. However, as is well understood, there is a tendency for grain 106 to settle near the outer perimeter of the interior volume 18 of the bin 10. Since the body 34 defining the arm of the sweeper 28 does not extend fully to the cylindrical sidewall 12 (e.g., so the sweeper may actual rotate in an uninterrupted or hindered manner), there is a need to blow the grain 106 away from the sidewall 12 so that the fins 40 can sweep the grain 106 toward the center for discharge. The discharge outlet 58 of the blower 52 is aimed downward toward the base 20 or the bottom of sidewall 12. The blown air from blower 52 causes the grain 106 to move away from the sidewall 12 and towards the center of the bin 10.

The blower 52 (or blowers 52 and 152, discussed infra) is selectively powered. In one embodiment, the blower may be hardwired to an electrical power supply of the grain bin 10. In another embodiment, the sweeper 28 may have a power outlet on the body 34 so that the blower 52 may simply be plugged into the sweeper 28 and receive electrical power therefrom. In another embodiment, the blower 52 (or blowers 52 and 152, discussed infra) may be battery powered. Once powered, the blower 52 is turned on. The impeller or fan in the blower 52 rotates in response to being driven by the motor 66. The rotation of the fan or impeller intakes air through the inlet 56. The impeller or fan increases the velocity of the air, under standard atmospheric pressure, and moves the air through the tube 62. The angle 64 of plate 60 that truncates the tube 62 to define the shape of the opening of the discharge outlet 58 further increases the velocity of the air being discharged. Air is discharged from outlet 58, as indicated by arrows 108, and blown forward, relative to the rotational path 104 of travel of the sweeper 28. The blown air, represented by arrows 108, is directed towards one or both of the lower surface at the base 20 of the grain bin 10 or the sidewall 12 of the grain bin 10. As the blown air, represented by arrows 108, is directed towards one or both of the lower surface at the base 20 of the grain bin 10 or the sidewall 12 of the grain bin 10, the grain 106 moves away from the sidewall 12 and toward the center of the bin 10 as indicated by arrows 110. Once the grain 106 has been moved away from the outer perimeter, the fins or paddles 40 may continue to encourage movement or move the grain 106 toward the center for discharge through the bore 24.

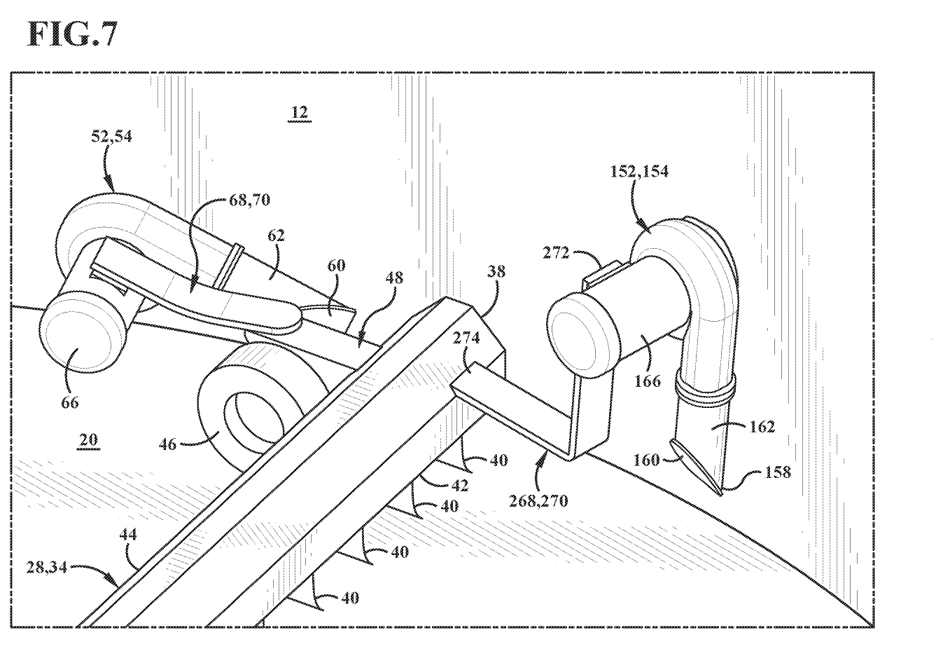

FIG. 7 depicts an alternative embodiment of the sweeper assembly of the present disclosure in which two blowers are utilized. Namely, the first blower 52 has the configuration and mounting arrangement previously indicated with respect to FIGS. 1-6. However, this embodiment shown in FIG. 7 adds a second blower 152 having many of the same operational components as blower 52. For example, the blower 152 has a housing 154 or casing that defines the outer shell that encloses the blower 152. The housing 154 may be designed to direct airflow efficiently and protect the internal components of the blower 152. The blower 152 may also include an impeller or fan (not shown), which is the rotating part of the blower 152 that draws air into the housing 154 and accelerates it outward through force (either centrifugal or axial force). The blower 152 detailed herein may have any type of impeller or fan to move air. The blower 152 includes an inlet, which is an opening where air enters the blower 152. The blower 152 also includes an outlet 158 that is at least partially defined by a plate 160 that truncates a portion of the housing 154 to decrease the area of the opening of the outlet 158 relative to an inner diameter of a tubular portion 162 of the housing 154. The angle at which the plate 160 truncates the tubular portion 162 may be similar to that as angle 64 described with respect to blower 52. The blower 152 has a motor 166, which provides the driving force for the impeller or fan, thereby providing the mechanical power needed to rotate the impeller and generate airflow. The motor 166 can be electric, gasoline, or diesel powered, depending on the application specific needs of the sweeper assembly detailed herein. However, it is envisioned that an electric motor is preferable for the second blower 152.

The second blower 152 is mounted forwardly or forward from the leading edge 42 on the body 34 of the sweeper 28. More particularly, the second blower 152 is mounted to the sweeper 28 via a second blower mount 268. The blower mount 268 includes a generally L-shaped body 270. The L-shaped body 270 includes a first end 272 and a second end 274. The first end 272 is fixedly connected to the second blower 152. In one particular embodiment, the first end 272 is connected with a mounting surface on the motor 166. The second end 274 of the L-shaped body 270 is fixedly connected to the body 34 of the sweeper 28. The second end 274 may be connected adjacent the radially extending leading edge 42 of the body 34. The body 270 of the second blower mount 268 extends forwardly, relative to the rotational path of travel of the sweeper 28, to cause the second blower mount 268 to extend outwardly from the sweeper 28 in a cantilevered manner. The L-shaped body 270 of the second blower mount 268 includes a first leg and a second leg that are generally at a right angle relative to each other. The first leg defines the first end 272 and the second leg defines the second end 274. The second leg extends in a generally horizontal manner and substantially parallel to the base 20. The first leg extends vertically upward to the first end 272. Thus, the blower 152 may be mounted to a forwardly facing surface on the first leg near the first end 272 thereof. This arrangement causes the blower 152 to be aimed generally downward to direct the blown air discharged from outlet 158 downwardly towards the surface of the base 20 or the outer perimeter near the base of the sidewall 12.

It should be appreciated that the control system 10 mentioned herein for controlling the blower 52 may be an on/off switch (not shown) or a more sophisticated and robust control system 109 as shown in FIG. 6A and described later herein.

In operation, the first blower 52 and the second blower 152 cooperate to blow the grain 106 simultaneously during the rotational sweeping action of the sweeper 28. The first blower 52 and the second blower 152 may be selectively powered via a common power supply or independent power supply.

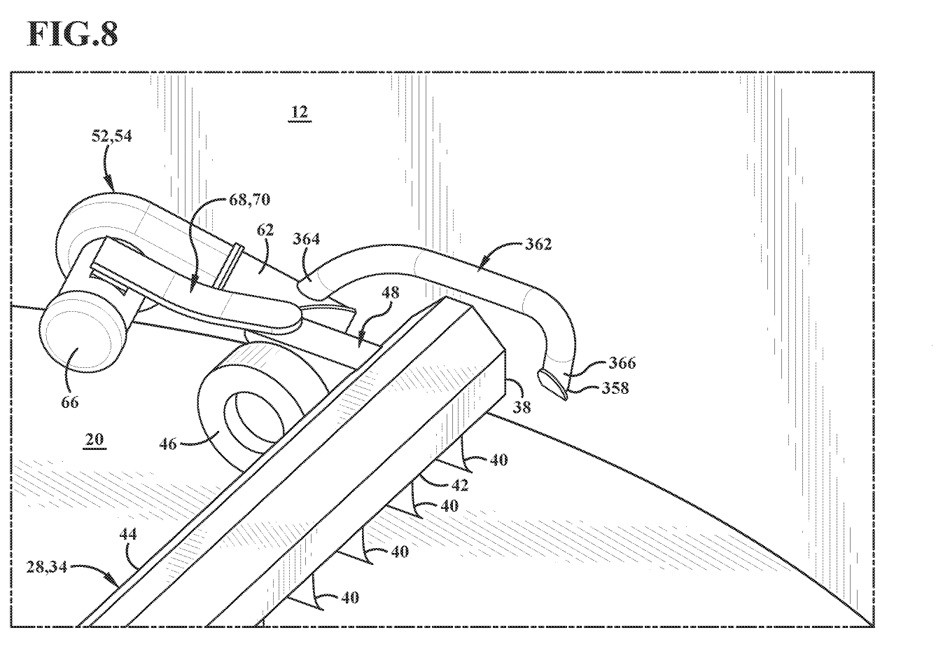

FIG. 8 depicts another alternative embodiment in which only the first blower 52 is utilized, however it should be appreciated that the blower 52 may include a secondary discharge port or discharge outlet 358. The blower 52 depicted in FIG. 8 can be modified with a tube 362 that it is in fluid communication with the internal bore of the tubular portion 62 on the blower 52. Thus, when the blower 52 is selectively activated or actuated, air being discharged through the tubular portion 62 can move towards the discharge outlet 58 but also extend through the tube 362 to be discharged from the second discharge outlet 358. The tube 362 extends from a first end 364 to a second end 366 that defines the secondary discharge outlet 358. The first end 364 may be rigidly connected to the exterior surface of the tubular portion 62 on the blower and may define an internal bore or volume that is in open communication therewith. The tube 362 may be a generally inverted U-shaped configuration extending between the first end 364 and second end 366 such that the second discharge outlet 258 is disposed forwardly of the radially extending leading edge 42 of the sweeper 28 relative to the rotational direction of travel of the sweeper 28. The assembly shown in FIG. 8 indicates that the two discharge outlets 58, 358 may be on opposite sides of the sweeper 28 relative to its rotational direction of travel. This enables air to be discharged out from the outlet 58 and the secondary outlet 358 both rearward and forward, respectively, of the sweeper 28 to agitate the grain 106 and encourage the grain to move towards the center of the grain bin 10 for subsequent discharge or removal from the grain bin 10.

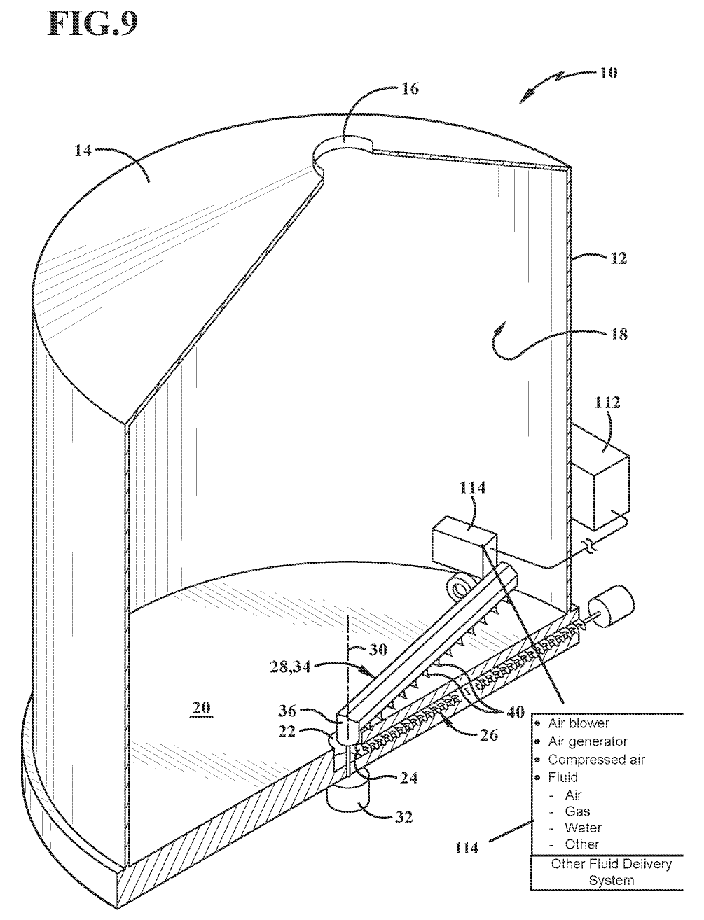

As mentioned earlier herein, features of the embodiments and the inventions described herein may be utilized to sweep or move the grain away from the corners of the grain bin 10. FIG. 9 shows an alternative feature wherein the blower may be replaced by an air generator, compressed air source, fluid generator for moving or exhausting air, gas, water or the like as mentioned earlier. In the event that a different fluid other than air is being used, such as another liquid, then a more robust fluid delivery system 114 (FIG. 9) may be provided.

Moreover, a remote source 112 may be situated outside the fluid supply source, such as a compressor tank coupled to a hose (not shown) that is situated outside the grain bin 10 with an operative exhaust end of the hose situated in proximity to the area to be cleaned, which in a preferred embodiment is a corner between the floor and the wall of the grain bin 10.

Advantageously, the embodiments described herein provide a system, method and apparatus for cleaning a predetermined area of the grain bin 10, such as the corner between the floor and the wall of the grain bin 10. As the sweeper arm 28 rotates, it directs the fluid to a predetermined location, such as outside a door (not shown) of the grain bin 10.

In one embodiment, the blower 52 (or blowers 52 and 152) and the sweeper 28 may be manually activated when an operator (such as a farmer) determines it is necessary to blow the grain 106. However, other embodiments utilize a controller or control system 109 and/or at least one sensor 111 to enable the blower and sweeper 28 to be automatically controlled via computer control logic that is programmed in a manner that controls the operation thereof. The controller or control system 109 and at least one sensor 111 allow real time monitoring and feedback of the sweep efficiency of the grain bin 10. When an automatic or computer controlled operation is implemented, the assembly or system of the present disclosure may additionally include one or more sensors to sense or gather data pertaining to the surrounding environment, grain 106, or operation of the assembly or system of the present disclosure. Some exemplary sensors capable of being the at least one sensor 111 and of being electronically coupled with the assembly or system of the present disclosure (either directly connected to the assembly or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid or air passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

If sensors are utilized to gather data relating to the assembly or system of the present disclosure, then sensed data, such as the presence of grain 106 near the outer perimeter of the grain bin 10, may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis, such as when to activate the blower 52 based on the amount of grain 106 near the perimeter of the bin 10. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy of activated the blower 52 to blow the grain 106. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the assembly or system of the present disclosure. In one embodiment, the assembly or system of the present disclosure can be used to teach a sensor model to predict sensor data for a specific scenario, such as when to activate the blower based on type of grain, the time of year, the ambient temperature, or volume of grain 106 within the grain bin 10. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the assembly or system of the present disclosure can use the sensors to acquire a representation of the real-world environment (e.g., a physical environment of the volume of grain 106 within the bin 10) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., depth maps of the grain, the angle of repose of the grain 106, or the volume of grain 106), classification data identifying objects (i.e., type of grain 106, such as corn, soybeans etc.) in the scene or surrounding environment, properties or classification data of components of the assembly or system of the present disclosure, or some combination thereof. Generally, the sensor model learns to predict sensor data from a representation of the scene, environment or operation of the assembly or system of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the assembly or system of the present disclosure may collect sensor data by fusing sensors as the vehicle traverses a real-world environment. The sensors of the assembly or system of the present disclosure may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the vehicle), vibration sensors, steering sensors, brake sensors (e.g., as part of the brake sensor system), and/or other sensor types.

In another embodiment, training data for the sensor model is generated based on simulated or virtual environments. The training data may then be used to train the sensor model for use in real-world autonomous applications, e.g., to control the operation of the device, assembly, or system of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

Hyperparameters are settings that govern the training process and behavior of AI models. Exemplary hyperparameters include learning rate, batch size, and regularization parameters. Adjusting these hyperparameters can impact the model’s convergence, stability, and generalization capabilities. For example, a higher learning rate may speed up training but risk overshooting optimal solutions, while a lower learning rate ensures precise adjustments but may slow down the process. Similarly, batch size affects gradient estimation and memory usage, influencing the model’s ability to learn effectively from the data. The number and type of layers in an AI model define its complexity and capacity to learn from data. Layers can be categorized into input, hidden, and output layers, each serving a specific function. Input layers receive raw data, hidden layers process and extract features, and output layers generate predictions. The depth of the model, determined by the number of hidden layers, allows it to capture intricate patterns and relationships in the data. For instance, DNNs with multiple hidden layers can learn complex representations, while shallow networks may be more suitable for simpler tasks. The architecture of an AI model refers to its overall structure and design, encompassing the arrangement of layers and connections. Different architectures may be tailored to specific types of data and tasks. For example, CNNs are well-suited for image data, leveraging convolutional layers to detect spatial features. Recurrent neural networks (RNNs) and their variants, such as long short-term memory (LSTM) networks, excel in handling sequential data by maintaining temporal dependencies. GANs and VAEs are used for generative tasks, creating new data samples based on learned patterns. The selection of hyperparameters, layers, and architectures directly influences the type of protocol or architecture employed in the AI model. For instance, a protocol designed for real-time data analysis may prioritize low-latency architectures with optimized hyperparameters for rapid inference. Conversely, a protocol for offline batch processing may focus on deep architectures with extensive layers to achieve high accuracy. The choice of architecture also affects the model’s ability to handle different data modalities, such as images, text, or sensor data, ensuring that the protocol aligns with the specific requirements of the task.

The assembly or system of the present disclosure may include hardware, software, and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the assembly or system of the present disclosure. In one example, the autonomous hardware, software, and/or firmware can be installed in and used to control the assembly or system of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the assembly or system of the present disclosure and/or stored in the data store. The training system can also incorporate or train up-to-date, real-time neural networks (and/or other machine learning models) for one or more sensor models.

The assembly or system of the present disclosure may include wireless communication logic coupled to sensors on the assembly or system of the present disclosure. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi^{®}, ZigBee^{®}, MIWI, BLUETOOTH^{®}) for communication. In one example, each of the devices, assemblies, or systems of the present disclosure may have its own IP address and may communicate directly with a router or gateway. This would typically be the case if the communication protocol is Wi-Fi^{®}. (Wi-Fi^{®} is a registered trademark of Wi-Fi Alliance of Austin, TX, USA; ZigBee^{®} is a registered trademark of ZigBee Alliance of Davis, CA, USA; and BLUETOOTH^{®} is a registered trademark of Bluetooth Sig, Inc. of Kirkland, WA, USA).

The system that receives and processes signals from the assembly or system of the present disclosure may differ from embodiment to embodiment. In one embodiment, alerts and signals from the assembly or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department or the farmer. Thus, if a particular assembly or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

The system also allows individuals to access the assembly or system of the present disclosure for configuration and diagnostic purposes. In that case, the individual processors or microcontrollers of the assembly or system of the present disclosure may be configured to act as Web servers that use a protocol like hypertext transfer protocol (HTTP) to provide an online interface that can be used to configure the assembly or system of the present disclosure. In some embodiments, the systems may be used to configure several assemblies or system of the present disclosure at once. For example, if several assembly or system of the present disclosure are of the same model and are in similar locations in the same location, it may not be necessary to configure the assembly or system of the present disclosure individually. Instead, an individual may provide configuration information, including baseline operational parameters, for several assemblies or system of the present disclosure at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the geometric shapes that were identified, it could be possible for those geometric shapes to be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

For example, although the assembly or system of the present disclosure is described as a complete unit within the present disclosure, it is to be understood that some of the components, such at the blower mount 68 or 168, or features detailed herein can be supplied as a retrofit kit. This approach enables the provision of only certain parts necessary to upgrade a legacy device to the specifications of the assembly or system of the present disclosure. Essentially, instead of requiring the replacement of an entire device (i.e., such as the entire sweeper 28), the retrofit kit allows for the selective enhancement of specific components. This could allow a user or operator to efficiently upgrade its/their existing legacy devices, systems, or assemblies to achieve the performance and functionality of the assembly or system of the present disclosure without a full replacement. For example, the farmer may simply purchase the blower mount 68, 168, and/or 268 and connect a blower 52 (and/or blower 152) to their existing sweeper 28. In the event that a component or portion of the assembly or system of the present disclosure is provided as part of a retrofit kit (such as just the blower mount 68, 168, or 268), those components may be integrated into legacy devices, systems or assemblies to upgrade the same. By facilitating partial upgrades, it addresses the need for continuous improvement and adaptation in dynamic environments where complete replacement might be neither feasible nor necessary. As a result, a user or operator would be able to make an enhancement, thereby extending the lifecycle, optimizing, or improving those legacy devices, systems, or assemblies.

The above-described embodiments can be implemented in any of numerous ways. For example, embodiments of technology disclosed herein may be implemented using hardware, software, firmware, or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the assembly or system of the present disclosure, which may include the logic(s) presented herein, includes the features, components, techniques, or processes detailed herein that, as combined, accomplished the desired results detailed herein. These specific elements, configuration or techniques of the assembly or system of the present disclosure, some of which may be included in at least one of the appended claims, accomplish these desired results to overcome the then existing problems in the relevant field of computer processor-based systems. Additionally, the features, components, techniques or processes of the assembly or system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the assembly or system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Advantageously, the system and method described herein are adapted to provide an improved sweeper assembly and system for cleaning out bins. While the blowers described herein have been shown blowing in the direction of the movement of the sweep arm, it should be appreciated that they could be directed in other directions, such as in a direction opposite of the movement of the sweep arm. This would permit the system to blow or move grain, for example, behind the sweep arm to facilitate movement of the grain.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

While the system, apparatus and method herein described constitute preferred embodiments of this invention, it is to be understood that the invention is not limited to this precise system, apparatus and method, and that changes may be made therein without departing from the scope of the invention which is defined in the appended claims.

What is claimed is:

1. A blower mount for a sweeper that pivots near a bottom of a grain bin, the blower mount comprising:
a body having a first end and a second end, wherein the first end is fixedly connected to the sweeper near a radially distal end thereof, and wherein the second end is fixedly connected to a blower that, when powered and selectively actuated, emits blown air toward at least one of the bottom of the grain bin or a sidewall of the grain bin; and
wherein the mount is configured to rigidly couple the blower to the sweeper.

2. The blower mount of claim 1, wherein the body of the mount extends rearward from the sweeper relative to a forward rotational path of travel of the sweeper.

3. The blower mount of claim 1, wherein the body comprises:
an upwardly facing top surface; and
a downwardly facing bottom surface.

4. The blower mount of claim 3, wherein the upwardly facing top surface is flat and planar in cross section.

5. The blower mount of claim 3, wherein the downwardly facing bottom surface is flat and planar in cross section.

6. The blower mount of claim 1, wherein the body comprises:
a substantially continuous outer surface that has an at least partially curved cross section.

7. The blower mount of claim 1, wherein the body is formed from a round rod, wherein the round rod is coiled between the first end and the second end to define a spring, wherein the spring resiliently moves and supports the blower.

8. The blower mount of claim 1, wherein the body is formed from a flat bar, wherein the flat bar is bent or curved between the first end and the second end to impart a resilient force exerted by the flat bar to support the blower.

9. A sweeper assembly for a grain bin comprising:
an elongated body defining an arm that extends from a proximal first end to a distal second end, wherein the arm rotates about a vertical pivot axis near the proximal first end, wherein during rotation the arm moves close to a lower surface of the grain bin to stir or agitate grain within the grain bin; and
a blower mounted to the arm near the distal second end, wherein the blower, when powered and selectively actuated, emits blown air toward at least one of the lower surface of the grain bin or a sidewall of the grain bin.

10. The sweeper assembly of claim 9, further comprising:
a mount that mounts the blower to the arm, wherein the mount includes a mount body having a first end and a second end, wherein the first end is fixedly connected to the arm near the distal second end of the arm, and wherein the second end of the mount body is fixedly connected to the blower.

11. The sweeper assembly of claim 10, wherein the mount body extends rearward from the arm relative to a forward rotational path of travel of the arm.

12. The sweeper assembly of claim 10, wherein the mount body comprises:
an upwardly facing top surface; and
a downwardly facing bottom surface.

13. The sweeper assembly of claim 12, wherein the upwardly facing top surface is flat and planar in cross section.

14. The sweeper assembly of claim 12, wherein the downwardly facing bottom surface is flat and planar in cross section.

15. The sweeper assembly of claim 10, wherein the mount body comprises:
a substantially continuous outer surface that has an at least partially curved cross section.

16. The sweeper assembly of claim 10, wherein the mount body is formed from a round rod, wherein the round rod is coiled between the first end and the second end of the mount body to define a spring, wherein the spring resiliently moves and supports the blower.

17. The sweeper assembly of claim 10, wherein the mount body is formed from a flat bar, wherein the flat bar is bent or curved between the first end and the second end of the mount body to impart a resilient force exerted by the flat bar to support the blower.

18. A method comprising:
selectively activating a blower mounted to a sweeper in a grain bin, wherein the blower is mounted near a radially distal end of the sweeper;
rotating the sweeper about a center pivot axis;
blowing air, from the blower, toward at least one of a lower surface of the grain bin or a sidewall of the grain bin while the sweeper is rotating; and
causing grain to move toward a center of the grain bin.

19. The method of claim 18, further comprising blowing air at atmospheric pressure.

20. The method of claim 18, wherein the blower is mounted in a cantilevered manner and positioned rearward of the sweeper relative to a rotational path of travel of the sweeper.

21. A storage bin having an internal cleaning system, said storage bin being adapted or suitable for storing grain or aggregate and the internal cleaning system comprising:
at least one control for controlling operating of the internal cleaning system;
a sweeper assembly having a drivable sweep arm having a first end pivotally coupled to permit the sweep arm to rotate or pivot in the storage bin;
an air generator situated proximate to a second end of drivable sweep arm; and
said at least one control being adapted to energize the sweeper assembly to rotatably drive said sweep arm in the storage bin and substantially simultaneously or independently control said air generator to blow air at a predetermined cubic feet per minute in order to cause said grain or aggregate to move away from an interior wall of said storage bin.

22. The storage bin of claim 21 wherein said at least one control controls at least one of a sweep arm speed and the air generator and the predetermined cubic feet per minute exhaust from the air generator in response to the grain or aggregate being swept.

23. The storage bin of claim 21 wherein said air generator is situated on said sweep arm in proximity to said second end such that an exhaust end of said air generator is situated between the distal second end and said interior wall of said storage bin.

24. The storage bin of claim 21 wherein said air generator further comprises:
a blower mounted to the sweep arm near the distal second end, wherein the blower, when powered and selectively actuated, emits blown air toward at least one of the lower surface of the storage bin or a sidewall of the storage bin.

25. The storage bin of claim 21 wherein said assembly further comprises:
a mount that mounts the blower to the arm, wherein the mount includes a mount body having a first end and a second end, wherein the first end is fixedly connected to the arm near the distal second end of the arm, and wherein the second end of the mount body is fixedly connected to the blower.

26. The storage bin of claim 21 wherein said second end of said sweep arm cooperates to define a gap between said second end and said interior wall of said storage bin, said air generator being mounted in proximity to said second end such that an exhaust port from said air blower is situated in operative relationship with said gap in order to facilitate blowing fluid into said gap, thereby cleaning a corner defined by a floor of the storage bin and said interior wall of said storage bin.

27. The storage bin of claim 26 wherein said fluid is air.
